(19) United States
(12) Patent Application Publication
(10) Pub. No.: US 2015/0206185 A1
(43) Pub. Date: Jul. 23, 2015

(54) System and Process for Distributing Coupon Codes or Discount Offers Via Short Code and SMS Mobile and Internet Technology for a Convenience Fee

(71) Applicant: Mike Gossett, Indianapolis, IN (US)

(72) Inventor: Mike Gossett, Indianapolis, IN (US)

(21) Appl. No.: 14/672,148

(22) Filed: Mar. 28, 2015

Related U.S. Application Data
(63) Continuation of application No. 14/200,511, filed on Mar. 7, 2014.
Application No. 14/200,511 is a continuation of application No. 13/658,366, filed on Oct. 23, 2012, now abandoned.
Application No. 13/658,366 is a continuation of application No. PCT/US2011/033578, filed on Apr. 22, 2011.
(60) Provisional application No. 61/327,332, filed on Apr. 23, 2010.

(51) Int. Cl. G06Q 30/02; H04M 15/00; H04W 4/14

(52) U.S. Cl. CPC G06Q 30/0257; G06Q 30/0267; G06Q 30/0273; H04W 4/14; H04M 15/68

(57) ABSTRACT

Among other things, there are disclosed systems and methods for providing coupons on demand to a consumer, to make the process of offering coupons and redeeming coupons more efficient. Embodiments of such systems may include a server reachable by mobile telephones or other communication devices with a database of coupon information, with modules or software for entering and administering coupon information and monitoring activity of coupons and reporting it to merchants. A consumer may text a keyword to a dedicated address, requesting coupons related to the keyword, and a selection of coupons (if any are available) is returned. If any coupon(s) are desired, they are returned to the consumer's mobile communication device, and a fee is added to the consumer's bill for the mobile communication device.

### REFERENCE TO RELATED APPLICATIONS

The present patent application is a continuation of U.S. patent application Ser. No. 14/200,511, filed Mar. 7, 2014, which was a continuation of U.S. patent application Ser. No. 13/658,366 filed Oct. 23, 2012, which was a continuation of International Patent Application No. PCT/US2011/033578, filed Apr. 22, 2011 which claims the benefit of U.S. Provisional Application No. 61/327,332, filed on Apr. 23, 2010, the entirety of all of which are incorporated by reference herein.

### FIELD OF THE INVENTION

The present disclosure relates to the creation of a consolidated system and process to allow consumers a much more convenient, on-demand means of acquiring coupon codes, discount offers, or similar benefits for retail goods or services, manufacturer's direct products and professional services for a convenience fee.

### BRIEF DESCRIPTION OF BACKGROUND

Presently, an enormous amount of time, money and effort are expended by businesses in order to advertise and distribute coupons, coupon codes, discount offers or other benefits (referred to herein as “coupons” or “coupon codes”) to attract consumers into their locations. For decades, businesses have relied on print ads in newspapers, direct-mail campaigns, radio and television to distribute such coupons, benefits or information widely to consumers. Consumers may purchase one or more newspapers or any of a variety of publications, spend an enormous amount of time searching for or reviewing coupons, clip out and organize at least those of interest, and schedule their day in an effort to redeem the most value possible.

Consumers today also get an extraordinary amount of unsolicited mail containing ads for products and services, up to and including direct mail such as Valpak, Money Mailers, RedPlum, and Reach. These various types of media are very expensive with very low redemption rates. Consumers must review these items to decide whether to use them, and organize them and their redemption as noted above. Regardless of the source of coupons, consumers frequently forget them or leave them at home, either losing their benefit or having to spend extra time and money to retrieve and redeem them. Budgetary or time constraints may not allow consumers to redeem such forgotten coupons inside the specific life or timeframe allotted for them.

Over the past few years, businesses have shifted their advertising efforts or “spend” to take advantage of the Internet. For example, businesses may launch on-line marketing campaigns leveraging tools such as Search Engine Optimization (SEO) to drive their respective products and services to the top of the most readily used search engines such as Google, Yahoo, Bing, etc. Moreover, businesses have increased their technology budgets to create multi-media Internet web sites in order to attract consumers and to sell products and services once consumers land on such web sites.

As the consumer adoption of this process increased, businesses moved to collecting permission-based e-mail lists of as many consumers as they could. Businesses also started tracking consumers' particular movements around their web sites to learn how to make the sites more efficient, in an effort to keep consumers engaged with the site and the business as long as possible. Such tracking included consumer purchase patterns, and using tools like ExactTarget and Constant Contact, businesses began marketing very specific products and services to consumers based on their buying patterns. As this marketing shift took off, so, too, did the number of opted-in, permission-based e-mail campaigns. Businesses became more aggressive about capturing consumer information by offering “white papers” in exchange for their contact data, and various other tactics such as surveys or sweepstakes to build a larger e-mail list. As these lists increased in number, the acquired detailed demographic data became valuable in the marketing world and businesses moved to sell this information. As more businesses shifted to search engine optimization processes in vying for the top spot in the search engine list, it became increasingly more confusing and difficult for consumers to search a broad category of a product or service to find the best deal, or to find coupons related to or effective in a defined location, e.g. a particular town, city or zip code.

Most recently, as consumers have increased the use and adoption of mobile phone technology, businesses have shifted attention toward that medium as a means of advertising and extending coupons. The use of SMS (Short Message Service) and MMS (Multimedia Messaging Service) to proactively market their products and services has seen a dramatic rise in the past year, where businesses are again building opt-in lists of mobile phone subscribers via the same process of e-mail opt-in lists. Businesses pay a third party to push SMS text blasts and MMS content-based e-mail blasts to the consumers who opted in to allow for such proactive e-mail blast marketing, which may include one or more coupon code(s).

Although the above-mentioned processes of acquiring coupons or coupon codes are somewhat effective, they lack a genuine convenience, effectiveness and efficiency for the consumer and/or the manufacturer, dealer and merchant. Currently a tremendous amount of capital is still spent on printed material for dispersal en masse. This process is condoned by sellers of product because of the simple cost of paper and ink, but nonetheless it is statistically ineffective either through short sale life of the coupon or by not reaching desired consumers. Internet marketing does not have the material waste but is steeped in cost due to the constant change required to stay current with trends and holidays. Like direct mail, it is not guaranteed to reach customers who are looking for particular coupons, goods or businesses. Every marketing campaign or change in advertising results in the company selling the product or service having to spend enormous amounts of money on the above-mentioned techniques, which are wholly incapable of meeting the dynamic needs of marketing and public relations alike.

Thus, it is clear that there is a great need for an improved system and process of providing a desired coupon to the consumer on demand, enabling the consumer to take control of when and where they want to do business, and generating efficiencies and marketing opportunities for business.

### OBJECTS AND SUMMARY

Accordingly, a primary object of the present disclosure is to provide a novel, convenient, on-demand process for finding benefits (e.g. coupon codes, discount offers, and the like) by way of a consolidated internet presence and use of SMS, MMS or other messaging technology to deliver coupons or coupon codes, whereby consumers are charged a convenience fee for ease of receiving on-demand the coupons or coupon codes, avoiding the shortcomings and drawbacks of prior coupon systems and processes. Businesses can register their coupons or offers and consumers can receive coupon codes on demand, within seconds, inside their timeframe and budget, for a nominal convenience fee.

Another object is to provide such a system and process whereby any type of product or service can be registered in the system and assigned a predetermined keyword (e.g. an alphanumeric indicator) that points directly to a coupon or category inside a specific timeframe of immediate request. Any and all mobile devices capable of SMS, MMS or similar messaging technology linked through predefined carrier networks within the system will be able to receive coupon codes.

Another object is to provide a system and process whereby users can search and find coupon codes or requested businesses by way of an improved internet application tool where all registered businesses are categorized and localized for ease of use.

Another object is to provide such a system in which businesses use this advertising process at no cost to them, and will be provided with redemption data and usage by way of a relational database in which a number of reports will delineate specific localized usage statistics.

Another object is to allow businesses to reduce their overall advertising spend, particularly print advertising spend, thus allowing them to promote themselves as a “green” company and ultimately reducing operating costs and promote constantly lower pricing to consumers as a result.

Among other things, there are disclosed embodiments of a system for efficiently providing coupons to consumers that includes a database having information concerning a plurality of coupons, such information including respective information for each respective coupon including a description of the coupon, a coupon code and a fee. A server is operationally connected to the database, and a connection means (such as an aggregator or gateway provider) for connecting a mobile communications device to the server is provided. The server is adapted to receive a request for at least one coupon from a mobile communications device, to determine via a query to the database whether a respective coupon meets the request. When the server determines that there is at least one coupon that meets the request, the server is adapted to send the coupon code for such coupon(s) to the mobile communications device and to send information concerning the fee for payment.

In particular embodiments, the server may be linked to at least one of a merchant registration, coupon creator and analytical dashboard modules. The respective information for a coupon can includes a rank datum used to determine an order of display of coupons to the mobile communications device. The rank datum may have an initial value at the time the coupon and its respective information is first entered into the database determined by at least one of the general relevance of the subject matter of the respective coupon to consumers, and a value of how popular the respective coupon will be with consumers. The rank datum is changeable automatically based on data of actual downloads of the respective coupon from the system. The server can include a coupon creator module, which may include an entry of or for the initial value of the rank datum.

An aggregator may be connected to the system, the aggregator being operable to pass the request from a mobile communications device to the server, and to pass the coupon code from the server to the mobile communications device. Such a coupon code is a part of a packet of information from the server, and that packet of information can further include the information concerning the fee. The aggregator is adapted to send at least part of the information concerning the fee for billing to the account of the mobile communications device. Each respective coupon is related to a respective merchant, and the server may be linked to an analytical dashboard module that is accessible on-line to the respective merchants to obtain information relating to the respective merchants' respective coupons. In specific embodiments, the analytical dashboard is customizable for each respective merchant to show one or more of a plurality of graphic data presentations desired by the respective merchant. Additionally or alternatively, the system may be adapted to send reports automatically to the respective merchants to reflect real-time activity related to their respective coupons. An on-line graphical user interface for researching availability of coupons in database by consumers is also disclosed.

In some embodiments, methods of efficiently providing coupons to consumers and providing feedback on coupon usage to merchants include entering respective information relating to a plurality of coupons, each of the coupons relating to a respective merchant, into a database, with the respective information for a respective coupon including a coupon code and a fee amount. At least some of the information relating to at least one of the coupons is provided to a consumer's mobile communication device in response to a query from the mobile communication device. A message relating to the at least one coupon is received from the mobile communication device, indicating one of acceptance or denial of the coupon(s). If that message indicates denial of the coupon(s), communication with the mobile communication device is terminated. If that message indicates acceptance of the coupon(s), a message from said database is transmitted to the mobile communication device that includes respective coupon code(s) and fee amount(s) related to the coupon(s). The fee amount is sent for inclusion in a bill for use of the mobile communication device.

Methods may also include making available to the respective merchant's information regarding activity of respective coupons relating to them in a password-protected analytical dashboard. The dashboard can be customizable for each respective merchant to show information desired by that respective merchant. The information can be made available via an Internet graphical user interface. Ranking the respective coupons can be performed, for example where the respective information for a coupon includes a rank datum. The rank datum is used to determine an order of display of coupons to the consumer or his or her mobile communications device, and it has an initial value at the time the coupon and its respective information is first entered into the database determined by at least one of the general relevance of the subject matter of the respective coupon to consumers, and a value of how popular the respective coupon will be with consumers. The rank datum is changeable automatically based on data of actual downloads of the respective coupon. The providing step noted above can include providing available coupons in a geographical area identified in the consumer query.

### BRIEF DESCRIPTION OF DRAWINGS

For a more complete understanding of how to practice the disclosure, the following detailed description of the illustrative embodiments should be read in conjunction with the accompanying drawings, wherein:

FIG. 1 is a schematic diagram of an illustrative embodiment of an entire mobile SMS communication process infrastructure shown embedded with an Oracle relational database, operating software, web server, and its real-time connection to an online registration form (a Merchant Registration Form or MRF), a Coupon Creator (CC) module, and an Analytical Dashboard (AD) via the Internet.

FIG. 2 is a schematic representation of a web-based, graphical user interface (GUI) display screen of a portion of a home landing page of a representative web interface.

FIG. 3 is a schematic representation of a web-based, graphical user interface (GUI) display screen showing the categorized and localized search results based on the search criteria selected on the universal home landing page of the web interface (e.g. of FIG. 2).

FIG. 4 is a schematic representation of a web-based, graphical user interface (GUI) merchant registration form (MRF) allowing for data entry of business information.

FIG. 4A is a schematic representation of a graphical user interface concerning a coupon creator as described herein.

FIG. 4B is a schematic representation of a graphical user interface concerning an analytical dashboard as described herein.

### DESCRIPTION OF ILLUSTRATED EMBODIMENTS

For the purposes of promoting an understanding of the principles of the disclosure, reference will now be made to the embodiments illustrated in the drawings and specific language will be used to describe the same. It will nevertheless be understood that no limitation of the scope of the claims is thereby intended, and alterations and modifications in the illustrated device, and further applications of the principles of the disclosure as illustrated therein are herein contemplated as would normally occur to one skilled in the art to which the disclosure relates.

As is presented in the drawings and described below, the present disclosure provides systems and methods for offering coupons or coupon codes in a more efficient way for both consumers and businesses. Businesses provide information concerning their coupons, offers or other enticements (generally “coupons”) to be entered into an electronic (e.g. Internet-based on-line system). Consumers interested in a particular product, service or business can connect with the system, e.g. via mobile phone, computer or similar device, to see if such coupons are available, and can choose to obtain one or more if desired. The system makes available to businesses data and reports concerning activity related to their respective coupons.

The embodiment of the system 3 shown in the drawings includes hardware and/or memory sufficient to conduct all of the actions described herein. In particular, it includes a server 20 which includes or is linked to a database 22, and which includes system software 24 with instructions for completing the actions. An aggregator or other gateway provider 2 is a part of or linked to server 20 to permit messages or signals to be received from and transmitted to customers' mobile phones or other message receivers. Server 20 is, includes or is connected to a web server 26 in this embodiment so that inputs to the system and requests for data and reports can be made over the Internet. A Linux-based operating system 28 is included to run software 24 and other parts of system 20. Administration console 30 is provided for administering system 20, back-up system 32 and remote hosting 34 are also provided. A web interface 36 provides password-protected access to system 20. MRF 38, coupon creator 40 and analytical dashboard 42 are software modules with graphical interfaces that permit easy entry and viewing of data, as further discussed below.

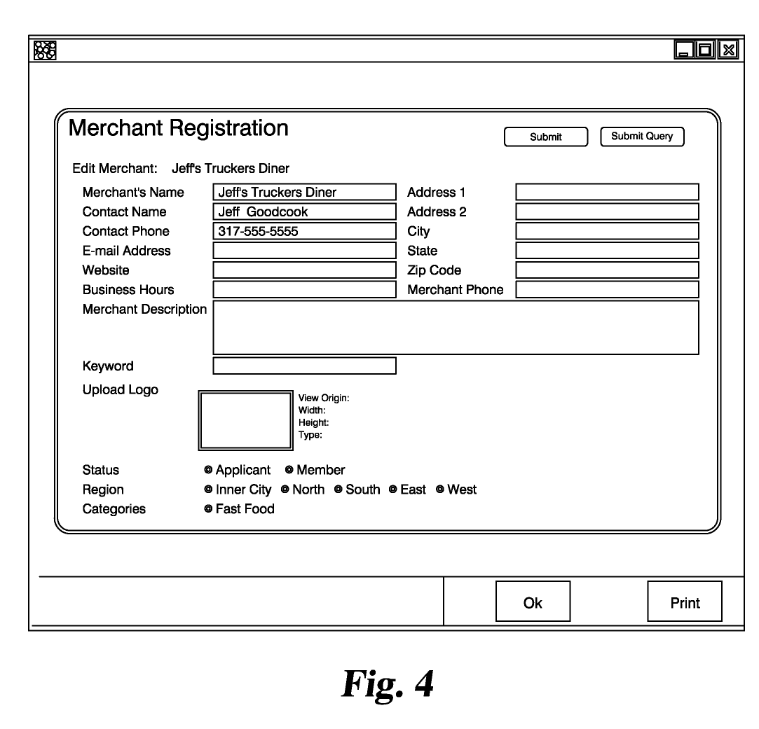

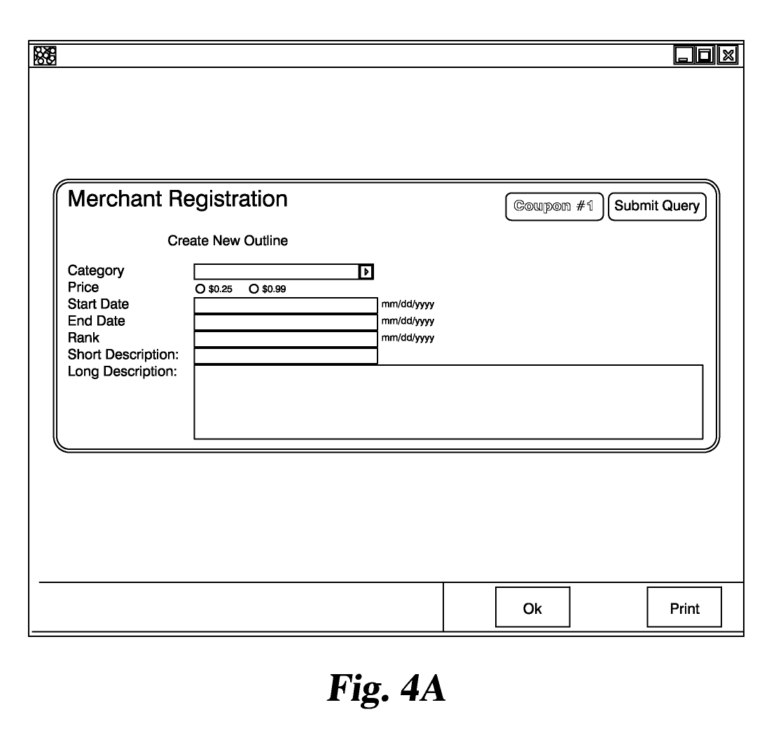

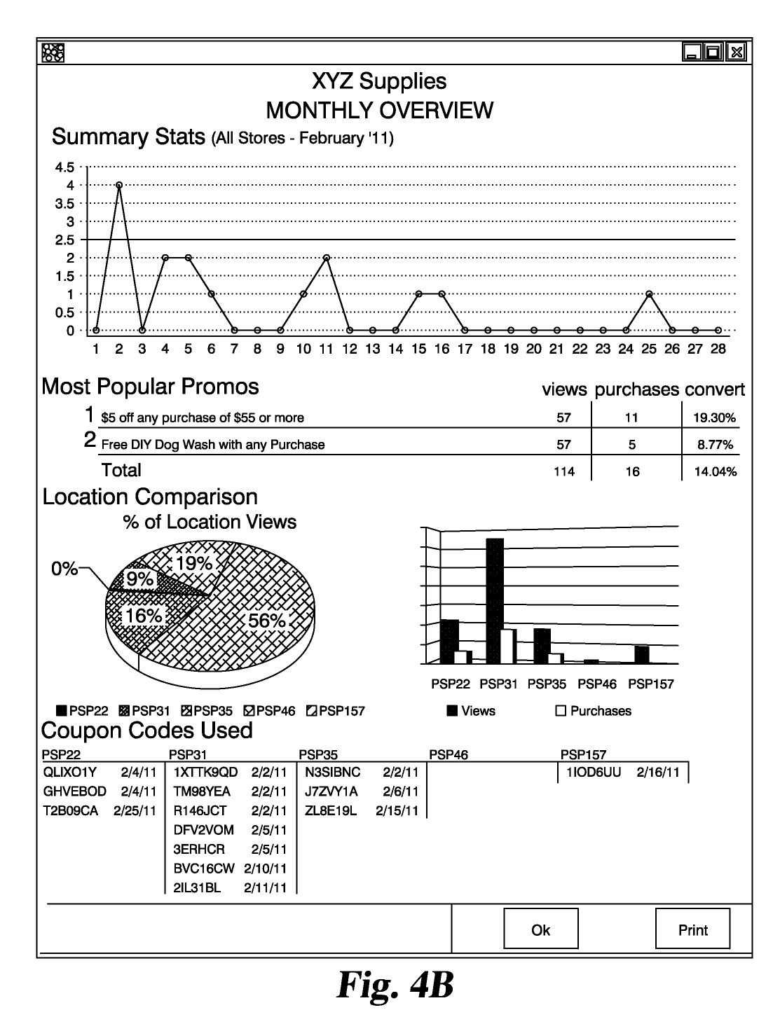

Information concerning respective businesses and their coupons are entered into database 22 (e.g. via server 26 or other database interface). In a particular example, an individual business provides information to an account representative, who then inputs the information into the system. Regardless of the method of input, the inputted information generally includes identifying information concerning the business, billing or other financial information, and information concerning the coupon(s) the business wishes to offer. A representative MRF is shown in FIG. 4, indicating information that may be taken to coordinate a merchant with system 20 and to correlate the merchant's coupons with the distribution, analysis and reporting features of system 20.

As to information concerning the particular coupon(s), system 3 includes a coupon creator (CC) module 40, which in particular embodiments is a software module that is a part of or run by the operating system 28. As exemplified in FIG. 4A, the CC 40 provides a graphical user interface (GUI) page that permits selecting a “New Outline” for a coupon. A section for amending existing coupons or outlines may be provided in other embodiments. After “New Outline” is selected, the user is then asked to identify a coupon category, from a list or by entry of text. As examples, categories can include indications of the type of good or service or the context of products or services, e.g. home, service, beauty, health, or the like. Categories may generally include the types of departments or sections in stores (e.g. “hardware” or “mens' wear”), as well as types of businesses (e.g. restaurants). A start date is entered in this embodiment (e.g. in mm/dd/yyyy format) to indicate when the coupon can begin to be offered through system 3. In some embodiments, there is an opportunity to enter an end date after which the coupon will no longer be offered through system 3. In other embodiments, no end date need be initially entered, and the coupon is removed as desired by the merchant at a later date by using the CC 40. As indicated above, it will be understood that some embodiments of CC 40 can permit altering or modifying existing coupons, as well as deleting them from system 3.

Information regarding a price or fee for the coupon to the consumer is also requested in this embodiment of CC 40 in system 3. One or more fee levels may be specified for coupons, or each coupon may be given a non-uniform or non-standard price. In a specific example, coupons with a face value of $3.00 or less (e.g., $1.00 off a particular product) have a price or fee at a lower level, e.g. $0.25. Coupons with a face value greater than $3.00 (e.g. 10 percent off an expenditure of $50.00 or more) have a price or fee at a higher level, e.g. $0.99. It will be understood that other fees or fee levels could be included in other embodiments. The price or fee is the amount charged to the consumer, as by adding the fee to the consumer's mobile phone charges as discussed herein, if the consumer accepts and receives the coupon.

The illustrated embodiment of CC 40 in system 3 includes a module or provision for providing an initial rank datum for the particular coupon and for dynamically changing that rank as the life of the coupon proceeds. In one particular example, the ranking is on a scale of 1-5, with 1 being the highest rank, and the coupon on creation is given an initial rank (e.g. by the merchant or by an account representative with access to system 3) between 2 and 5 inclusive. The initial rank is determined in one embodiment by a combination of two factors, one indicating the general relevance of the subject matter of the coupon to consumers, and one reflecting a judgment of how popular the coupon will be with consumers. An example of the former factor would be that a coupon relating to dog food would be considered higher in rank than a coupon relating to snake food, as dog food is much more in demand than snake food. An example of the latter factor would be that a coupon having a greater face value or greater applicability (e.g. available in more geographic locations) than another would be considered higher in rank.

With these two factors, an initial rank of the coupon is determined. As the coupon is active and available for access by consumers, a third factor may change the rank in some embodiments, that of popularity. That is, a coupon that proves very popular with consumers, as evidenced by number of accesses over a particular time period, is upgraded in rank, while a less—or unpopular coupon may be downgraded in rank. In particular embodiments, the rank of a coupon is re-evaluated each day. The rank datum for the coupon, if present in an embodiment, affects or determines the order of display or prominence of the coupon compared to other coupons. For example, in a case in which a consumer requests pet food coupons, those having a higher rank may be listed first. Change in the respective ranks of coupons over short or longer terms is thus possible in such embodiments.

The data or information entered via CC 40 concerning a coupon can also include a “short description,” which is the verbiage that a customer receives from system 3 to his or her mobile phone. In particular embodiments, the short description is 35 characters or less and includes as much description as possible concerning the coupon or offer. A “long description” can also be added, in which fuller detail of the coupon offer is spelled out. In a current embodiment the long description has a maximum of 120 characters. CC 40 may include a number of additional pieces of data or functionalities. Among these are the ability to add stores or locations to the listed areas where a coupon is valid. A scheduler can be included to automatically release coupons or offers after a certain amount of time or number of uses. Reporting on a scheduled basis or in real time for particular coupons may be arranged. A catalog of available coupons for a particular merchant can be created through CC 40 in some embodiments.

In FIG. 4B, an exemplary GUI is shown which in a practical embodiment is called the “analytical dashboard” (AD) 42. The AD 42 is developed and organized to allow merchants or other coupon providers the capability to access relevant data regarding their coupons in real time. System software 24 has access to the performance data collected concerning each coupon, and on accessing the AD and making a request (e.g. through web interface 36) displays or reports all or selected components of such data in an easy-to-read format. The AD 42 thus delivers quickly information so as to permit greater control by the coupon provider of its or its coupons' performance as a part of system 3.

The AD 42 of FIG. 4B features point-and-click interfaces for accessing data or reports, with a variety of graphical indicators allowing individual businesses (coupon providers) to visualize daily activity involving its coupons. It thus affords each business the opportunity to make meaningful decisions and quickly take action relying on or directly from the dashboard.

In particular embodiments, the AD 42 goes beyond a display and comparison of actual data and target numbers of merchants or coupon providers, displaying information linked to an organization's strategy, cause-and-effect relationships and business process. For example, the particular display(s) and/or report(s) (e.g. FIG. 4B) provided for a particular business is determined by the business either in initially registering the business in system 3, or by later access to the AD 42 via a password. Thus, the business can create a secure set-up for the data that it wishes to view when it accesses AD 42. A specific embodiment of AD 42 provides eleven options of data that can be provided or displayed, and each business can choose from those options, as well as choosing particular formats for the options. Among those options, as seen in FIG. 4B, are summary statistics, most popular promotions or coupons, location comparisons, coupons or codes used, and the like. Other options that may be available relate to or include numbers of purchases, numbers of times shown in search engine results, views to a merchant's corporate or main website, views to a merchant's full profile in system 3, industry comparisons, numbers of positive social-media events (e.g. added Facebook ‘Likes’), and store-by-store and/or headquarters business views.

The AD 42 may be used to provide data compatible with individual business' systems and databases to the business, so as to create or make available an integrated view with data from all their systems, or allow them to view metrics from the systems individually. The AD 42 provides data accessible via password regarding the particular merchant's coupons in real time. With such data, a business can display or develop forward-looking indicators for its coupon efforts, giving decision makers early warning of potential problems to be prevented, or confirmation that the forecast is bright so needless preventative measures can be avoided. Information from AD 42 may be used to manage a business' complex operations along with its other tools, such as relational databases, Excel reports, web sites, Business Intelligence, and other real time systems. The GUI of AD 42 permits reports or displays from it to be viewed on any computer or device that has a web browser, including telephones or other mobile devices.

A particular feature available through an embodiment of AD 42 is the ability to send scheduled e-mails or other messages concerning performance of a business' coupons or other data. As one example, the business (via password access to AD 42 or through an administrator of system 3) can instruct system 3 or AD 42 to send an e-mail at a particular time (e.g. daily or weekly) with report(s) or display(s) of particular data or other key performance indicators established by the business. As another example, an e-mail or other message can be generated and sent from system 3 or AD 42 whenever particular indicator(s) or information has a defined criterion, such as an indicator outside of a pre-defined range. Thus, such as special or “score-based” e-mail or message might be generated when a coupon has more activity than expected, or has little or no activity, depending on the criteria for such message set up by the business. The business can accordingly be immediately informed of the occurrence of a defined coupon contingency.

Accordingly, AD 42 as a part of system software 24 effectively provides the ability to view multiple sets of information regarding coupon usage at the same time. It allows a business to move from an overall dashboard view of many or general information directly to the details in the application where the data originates. System 3 and AD 42 allows a business to keep communication with its own databases and business-managing tools. For example, information concerning particular indicators or the entire performance dashboard concerning coupons can be provided in an e-mail to share with colleagues, shareholders or others, with or without annotations to from other business information to add context and understanding. Snapshots of coupon-related data is thus available, e.g. at set intervals, that can be compiled to give insight into trends and history.

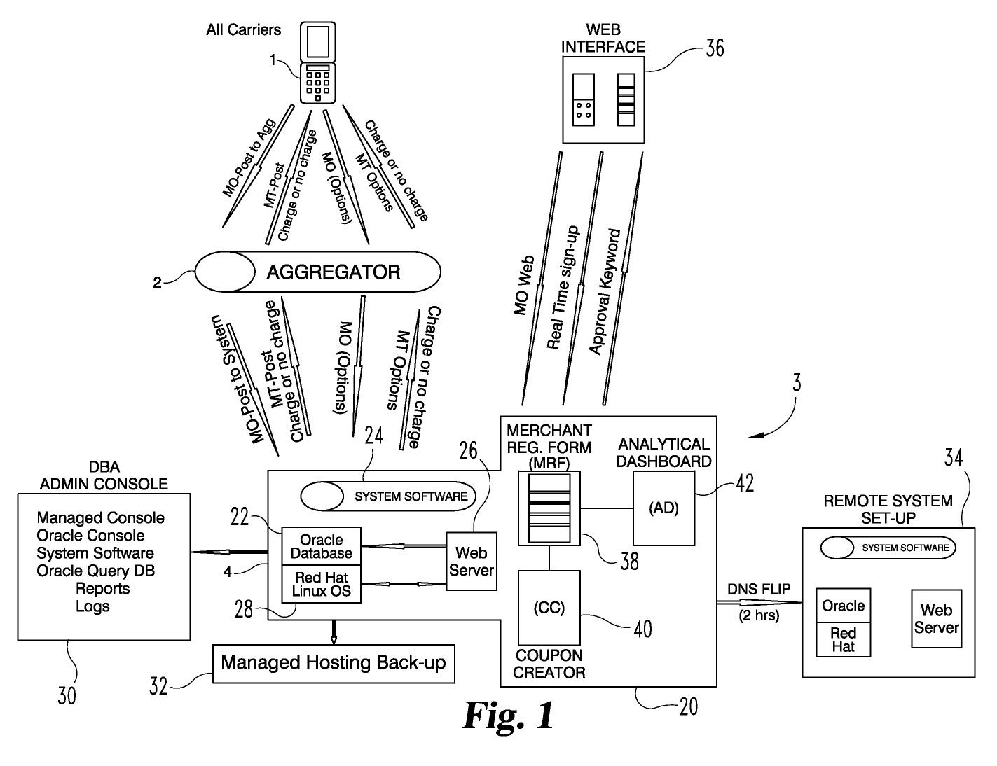

System 3 includes a number of coupons from a number of coupon providers, easily available at the request of consumers who desire them, but not sent out in blanket or haphazard fashion. The consumer determines whether to receive or download one or more coupons, as indicated below. As indicated by FIG. 1, access by consumers to an embodiment of system 3 begins with a telephone or other messaging or mobile communication device 1 of an individual consumer or other user. The terms “mobile communication device” and “messaging device” are meant to include any of a variety of mobile communications tools (such as telephones, PDAs, Blackberry devices, and the like) having the capability of sending and receiving text or other data via a messaging protocol or service (e.g. SMS, MMS or other transfer technologies). The consumer uses the messaging device (1) to transmit a keyword or similar information reflecting a business or other entity from whom the consumer desires a coupon, or to see what coupons may be available from that entity, or for particular goods or services or a category of goods or services. For example, the consumer might text the name of a restaurant to a particular five-digit number (a “short address”), e.g. 44321. Such a mobile-originated post is represented by the “MO-Post to Agg” arrow, and it is transmitted to an aggregator or other gateway provider 2 related to the service-provider of the consumer's messaging service.

The message is then transferred by the gateway or aggregator 2 to a server 3 designated as associated with the particular five-digit number or other short address to which the message was texted (the “MO-Post to System” arrow). In this particular embodiment, server 3 is an SMS server. The SMS server includes or is linked to a database 22 (in this embodiment, an Oracle database) and having an appropriate operating system 28 (in this embodiment, a Linux operating system such as those available through Red Hat). These items are generally shown as a unit at 4, although it is understood that they may be physically separate as well. Server 3 may also include or be linked to a web server 26 (indicated by the “Link” double-arrow) and able to accept inputs and queries from the Internet (indicated by the “MO Web” arrow), as will be described further below. It will be understood that web server 26 may be a part of or separate from other parts illustrated in unit 4. Administration of server 3 is provided through DBA Admin Console 30, to manage the hardware and software noted above, to allow input and output for account managers or other administrators, and to develop reports, logs and other information from the server(s) and database(s). Back-up in the illustrated embodiment is indicated at 32 in terms of a managed hosting back-up.

When server 3 receives the message posted from a mobile communicating device 1 to a short address, as noted above, the keyword entered by the consumer is used to find coupons (if any) that are available from the business or in the category related to the keyword. For example, if the business or entity of interest is the “A Restaurant,” a keyword related to that business may be ARESTAURANT. The consumer, having found the keyword from a prior inquiry, on-line via web serve 26 or from another source, sends that keyword, e.g. via SMS to the appropriate short address. Aggregator or gateway 2 receives that sent message from device 1, and the particular short address causes the message to be routed to server 3. Server 3 takes that keyword and queries database 22 for coupons, discount offers or other benefits related to the business associated with the keyword as set up in the MRF 38 or CC 40, e.g. “A Restaurant.” Based on the result of the query, server 3 returns a mobile-terminated message (indicated by the “MT-Post” arrow from server 3) to the consumer's device 1 via aggregator 2, indicating either that there are no coupons available, or indicating what coupon(s) are in fact available. If no coupons are available, the consumer can terminate the transaction without any fee for coupons, as by pressing one or more keys (e.g. a key corresponding to “NO”) to send an ending message (represented by the “MO (Options)” arrow), which when received by server 3 via aggregator 2, results in termination of communication between server 3 and device 1.

If one or more coupons are available, the consumer has the option to accept such coupon(s) or not. For example, a list of coupons can be provided via aggregator 2 to device 1 (indicated by “MT-Post” arrow). A choice among them can be made by the consumer, as by pressing one or more buttons on device 1, with or without a separate confirmation step. If the consumer chooses not to accept any of the coupon(s), as by pressing one or more keys to send a rejection message, similar to the ending message noted above, then the transaction is terminated without cost to the consumer. In certain embodiments, the consumer may be able also to send additional information to server 3 subsequent to or with the original keyword, such as zip code or other location information along with a keyword, to help narrow down a set of possibly useful coupons to particular location(s).

If a consumer chooses to accept one or more coupons, or if other options are provided for the consumer, then the consumer sends a reply message (indicated in the “MO (Options)” arrow) with an acceptance and an indication of which coupon(s) or option(s) are accepted. The acceptance may be in the form of an alphanumeric message, and such messages of three or five characters are believed to be particularly effective. That reply message is transmitted via gateway 2 to server 3. Server 3 may provide additional information via gateway 2 to device 1 if a request for options is made by the consumer. On receipt of a reply accepting one or more coupons, server 3 performs two functions. A coupon code (e.g. an alphanumeric code, bar code, time stamp or other identifier) is sent to the consumer, and a record is made of the transaction which is used to enter a charge on the consumer's bill for his or her device 1, or other message-service bill.

For example, upon receiving the acceptance (e.g. alphanumeric message) from the consumer, system 3 creates a message in response (indicated by the “MT Options” arrow). As with other messages indicated herein, the response message may be an XML package that includes one line of information that is text to be sent (e.g. the coupon code along with a “thank you” statement) and several additional lines of technical information. Among the technical information is a trigger or fee indicator that represents the cost, price or fee for the coupon. As the coupon code is sent to the consumer, the trigger or fee indicator is read (e.g. by aggregator 2), and a corresponding message is sent to the consumer's service provider for inclusion in the consumer's bill.

The coupon code is sent (as indicated by the “MT Options” arrow) via aggregator or gateway 2 to the consumer's messaging device 1. As already noted, a fee for the coupon ($0.25 or $0.99 in the above-noted specific examples) will be added to the consumer's bill for device 1 or for the messaging service used, via aggregator 2 and/or system 3, for the convenience of the program being an on-demand service. The consumer can then show the coupon code received on his or her device 1 to the business's personnel, who can enter the code (as by keypad entering, scanning or other ways) to enable use of the coupon. The coupon code may remain accessible in or from the consumer's messaging device for a particular period of time, may be rendered inaccessible when scanned or used, or may be rendered ineffective in the business's automated systems once used. In one example, system 3 provides a random alphanumeric code (e.g. a seven-digit alphanumeric code from a random generator associated with system 3) electronically attached to the coupon when the coupon is sent to the consumer. Once the consumer uses the coupon, the alphanumeric code is read or entered by the merchant and compared to other codes associated with that coupon. A future use of the same coupon would be denied because the random alphanumeric codes match. In other examples, the merchant may provide a code to system 3 (e.g. during registration or set-up, as discussed above) that is useful with its internal systems (such as point-of-sale hardware or software) to ensure a single use of the coupon. Of course, the merchant may also permit the coupon to be used multiple times up to an expiration date or time.

In one illustrative example, a consumer may be away from home and considering where he or she would like to eat. Noticing “A Restaurant” nearby, the consumer takes out his or her mobile communication device 1 (e.g. mobile telephone), and texts an appropriate keyword (e.g., ARESTAURANT) to the short address dedicated to system 3 for texting (e.g. 44321). Aggregator 2 receives the message and passes it to system 3 as discussed above. System 3 transmits back to the consumer's telephone 1 an indication that there is a 10-percent-off coupon available for at least certain locations of A Restaurant. If the consumer decides not to accept the coupon, he or she transmits a rejection or otherwise terminates the messaging transaction. If the consumer decides to accept, he or she transmits an acceptance message or reply. System 3 transmits the coupon code for A Restaurant previously entered into database 22 to the consumer, and notes information concerning the acceptance for billing to the consumer's telephone or messaging service bill via his or her telephone or messaging service carrier. The charge is small relative to the savings afforded by the coupon, and the convenience to the consumer of instant, on-demand coupons without the time and organization needed to clip and carry coupons makes the service worthwhile. Businesses save money on inaccurately directed paper mailings and other coupons, with their coupons going directly to consumers who are far more likely to visit the business and purchase its goods or services.

The system 3 allows the consumer to compare competing businesses' offerings in real time. If the consumer has a choice among several restaurants or other retailers, for example, he or she can check each restaurant's or retailer's coupon offerings, if any, in making a decision as to where to spend money. Reports from the system or data in the system to individual retailers can provide information as to the effectiveness of its coupon or other marketing strategies, as well as increasing traffic and sales.

A remote system set-up 34 can also be provided as a back-up or as a means for overflow access to the on-demand coupon system noted above. Structurally and functionally it is similar or identical with server 20 and its associated database(s), operating systems, links and/or other components. It is linked with server 20 via DNS FLIP technology (Domain Name System Fast-Local-Internet-Protocol).

As noted above, a web server 26 or other internet connection to server 20 may be provided, and in particular embodiments consumers and businesses alike can access at least some information in server 26. For example, in some embodiments consumers can access (e.g. via a web interface 36) what businesses or other entities have or may have available coupons in the system, and what their keywords are, for use when the consumer is later away from home. Consumers can also make arrangements via the GUI web interface 36 to load coupon(s) or coupon code(s) to the consumer's messaging device, in some embodiments. For example, the consumer can locate coupon(s) via the web interface 36, place them in a virtual “shopping cart,” and provide information (e.g. billing information) to complete the transaction. Server 20 transmits the coupon(s) or code(s) as noted above, with the above-discussed nominal charge to the consumer's telephone or messaging bill if he or she was not charged directly through the web interface 36.

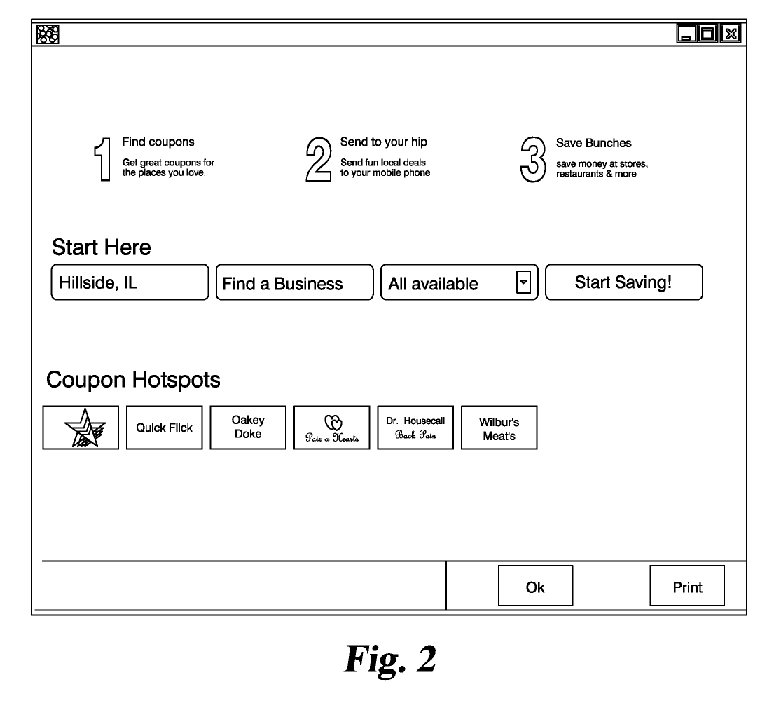

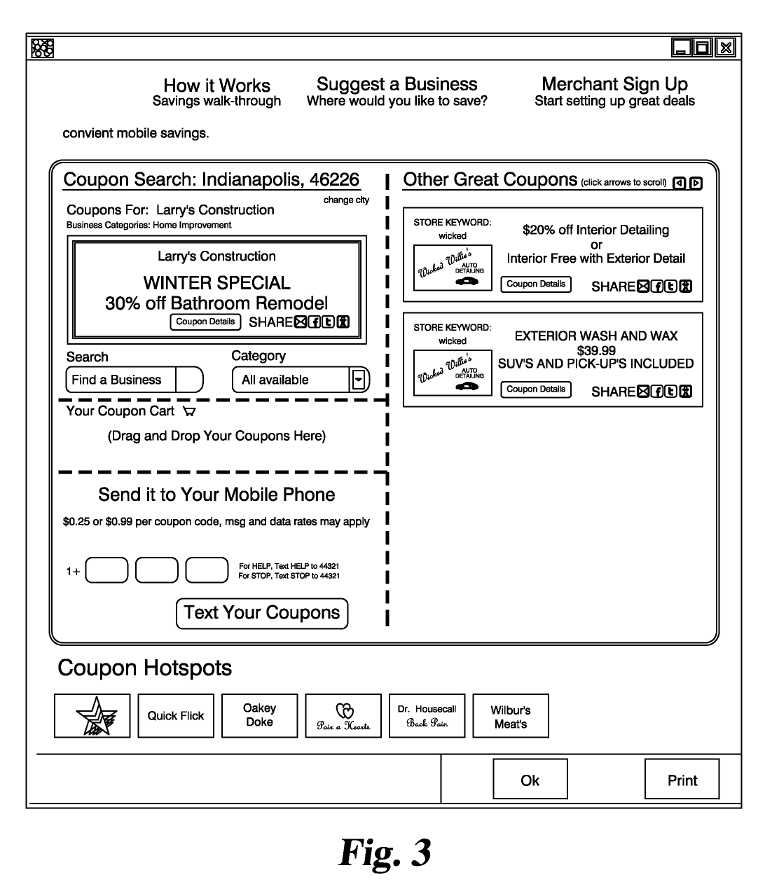

As indicated above, businesses can add to, subtract from or otherwise alter their coupons (e.g. offers, effective dates, etc.), profiles, or other related information. Such coupon alteration, addition, or other management is done through the CC 40 and AD 42. As seen in FIG. 1, web interface 36, such as a graphical user interface, allows consumers or businesses to send such requests or information (indicated by the “MO Web” arrow) or businesses to sign up their offers, e.g. via account managers or other system administrators (indicated by the “Real time sign-up” arrow). An example of such a GUI is shown in FIGS. 2-3, and examples of automated forms for sign-up are shown in FIG. 4. Information is transmitted back, such as keywords to a consumer (indicated by the “Approval Keyword” arrow) or usage information to a business. As indicated above, businesses (i.e. merchants) can access information concerning their coupons via web interface 36 and AD 42.

It will be understood that the above-described systems, structures and methods are exemplary only, with a variety of other functions and structures being useful as suggested above.

While the disclosure has been illustrated and described in detail in the drawings and foregoing description, the same is to be considered as illustrative and not restrictive in character, it being understood that only the preferred embodiment has been shown and described and that all changes and modifications that come within the spirit of the disclosure are desired to be protected. It will be evident from the specification that aspects or features discussed in one context or embodiment will be applicable in other contexts or embodiments.

What is claimed is:

1. A system for providing coupons to a consumer on demand, the system comprising:
a host computer system;
a database maintained in computer memory of the host computer system, the database containing a plurality of coupon keywords each one of which is associated with a business, and coupon data for coupons of the business, the coupon data including coupon description and a convenience fee;
a communications interface connected to the host computer system, the communications interface providing communication between the host computer system and a mobile communications device;
a random coupon code generator associated with the host computer; and
program instructions stored in the computer memory of the host computer system, the program instructions allowing the host computer system to:
receive a message from a mobile communications device via the communications interface, the received message including a message keyword;
query, in response to the received message, the database to match the message keyword with one of the plurality of coupon keywords;
send, in response to the received message, coupon data of the coupons of the business associated with the matched coupon keyword and coupon acceptance data to the mobile communications device via the communications interface;
receive a coupon acceptance message from the mobile communications device via the communications interface indicating acceptance of a coupon associated with sent coupon data of a coupon of the business;
generate a random coupon code via the random coupon code generator;
store the generated random coupon code in the database;
associate the generated random coupon code to the business;
send, in response to the coupon acceptance message, the generated random coupon code to the mobile communications device via the communications interface;
bill the convenience fee of the coupon data of the accepted coupon to an account associated with the mobile communications device via the communications interface; and
receive usage information from the business via the communications interface indicating that the generated random coupon code has been used at the business.

2. The system of claim 1, wherein the random coupon code generator is configured to generate a random alphanumeric coupon code.

3. The system of claim 2, wherein the generated random alphanumeric coupon code comprises a generated random seven-digit alphanumeric coupon code.

4. The system of claim 1, wherein the program instructions allow the host computer system to store the received usage information in the database.

5. The system of claim 4, further comprising:
an analytical dashboard module associated with the host computer system, the analytical dashboard module generating data regarding the usage information; and
the communications interface further provides communication between the host computer system and an Internet communications device;
wherein the analytical dashboard module is accessible to the business by the Internet communications device via the communications interface.

6. The system of claim 5, wherein the analytical dashboard module is customizable by the business through the Internet communications device via the communications interface.

7. The system of claim 5, wherein the analytical dashboard module is available to the business by an Internet graphical user interface via the communications interface.

8. The system of claim 5, wherein the analytical dashboard module automatically sends real-time reports regarding the usage information to the business via the communications interface.

9. The system of claim 1, wherein the program instructions further allow the host computer system to receive SMS messaging from the mobile communications device via the communications interface, the SMS messaging including the message keyword.

10. The system of claim 1, further comprising:
a coupon creator associated with the host computer system, the coupon creator accessible to the business via the communications interface and allowing the business to create coupons for free.

11. The system of claim 10, further comprising:
a merchant registration system associated with the host computer system, the merchant registration system allowing the business, via the communications interface, to register the business with the host computer for free, and to access the coupon generator for free.

12. In a system having a host computer system, a database maintained in computer memory of the host computer system, and a communications interface connected to the host computer system, the communications interface providing communication between the host computer system and a mobile communications device, a method of providing coupons on demand to a consumer, the method comprising:
allowing the database to contain a plurality of coupon keywords each one of which is associated with a business, and coupon data for coupons of the business, the coupon data including coupon description and a convenience fee;
receiving a message from a mobile communications device via the communications interface, the received message including a message keyword;
querying, in response to the received message, the database to match the message keyword with one of the plurality of coupon keywords;
sending, in response to the received message, coupon data of the coupons of the business associated with the matched coupon keyword and coupon acceptance data to the mobile communications device via the communications interface;
receiving a coupon acceptance message from the mobile communications device via the communications interface indicating acceptance of a coupon associated with sent coupon data of a coupon of the business;
generating, in response to the coupon acceptance message, a random coupon code via a random coupon code generator associated with the host computer system;
storing the generated random coupon code in the database;
associating the generated random coupon code to the business;
sending the generated random coupon code to the mobile communications device via the communications interface;
billing the convenience fee of the coupon data of the accepted coupon to an account associated with the mobile communications device via the communications interface; and
receiving usage information from the business via the communications interface indicating that the generated random coupon code has been used at the business.

13. The method of claim 12, wherein the random coupon code generator is configured to generate a random alphanumeric coupon code.

14. The method of claim 13, wherein the generated random alphanumeric coupon code comprises a generated random seven-digit alphanumeric coupon code.

15. The method of claim 12, further comprising:
storing usage information in the database.

16. The method of claim 15, further comprising:
providing an analytical dashboard module associated with the host computer system, the analytical dashboard module generating data regarding the usage information; and
allowing the analytical dashboard module to be accessible to the business by an Internet communications device via the communications interface.

17. The method of claim 16, further comprising:
allowing the analytical dashboard module to be customizable by the business through the Internet communications device via the communications interface.

18. The method of claim 16, further comprising:
allowing the analytical dashboard module to be available to the business by an Internet graphical user interface via the communications interface.

19. The method of claim 16, further comprising:
automatically sending real-time reports from the analytical dashboard module regarding the usage information to the business via the communications interface.

20. The method of claim 12, further comprising:
receiving SMS messaging from the mobile communications device via the communications interface, the SMS messaging including the message keyword.

21. The method of claim 12, further comprising:
providing a coupon creator associated with the host computer system, the coupon creator accessible to the business via the communications interface and allowing the business to create coupons for free.

22. The method of claim 21, further comprising:
providing a merchant registration system associated with the host computer system, the merchant registration system allowing the business, via the communications interface, to register the business with the host computer for free, and to access the coupon generator for free.
